(19) United States
(12) Patent Application Publication
(10) Pub. No.: US 2024/0370006 A1
(43) Pub. Date: Nov. 7, 2024

(54) A TYPOGRAPHICAL-BASED DIGITAL SIGNATURE FOR HOUSEHOLD EQUIPMENT

(71) Applicant: LIFEWHERE, LLC, Golden Valley, MN (US)

(72) Inventors: Brian Scott Courtney, Austin, TX (US); Brenden Knecht, Austin, TX (US)

(73) Assignee: LIFEWHERE, LLC, Golden Valley, MN (US)

(21) Appl. No.: 18/552,658

(22) PCT Filed: Mar. 26, 2021
(86) PCT No.: PCT/US2021/024443

§ 371 Date: Sep. 26, 2023

(51) Int. Cl. G05B 23/02

(52) U.S. Cl. CPC G05B 23/0221; G05B 23/0283

(57) ABSTRACT

This disclosure creates a language that may describe how any type of equipment behaves. The scalable language may uniquely identify equipment and components of equipment. The language includes “words” comprising characters that can describe the sequence of operations of the equipment. The characters may describe characteristic signatures in power consumption signals of the equipment as well as components of the equipment over an operational cycle of the equipment. The characters, e.g., “glyphs” or “runes,” may use a scale-free format modeled after typography. These characters may be scaled to give different confidence levels when comparing the characters to monitored power consumption signals. The language also describes how the equipment transitions between events during the sequence of operation. A compiler may use this language to generate programming instructions that may cause processing circuitry to efficiently monitor equipment, including determining a state of health of the equipment.

### TECHNICAL FIELD The disclosure relates to performance analysis of equipment.

### BACKGROUND

Performance monitoring for equipment can be characterized in a variety of ways. One way is to monitor efficiency, e.g., energy input to energy output, run time, mean time between failure and so on. Another way may include monitoring the power characteristics, such as look at the power (watts), voltage-amperes reactive (vars) or electrical current (amperage) over time.

### SUMMARY

In general, the techniques of this disclosure create a language that may describe how any type of industrial or household equipment behaves. In other words, the disclosure describes techniques to define a scalable language to uniquely identify equipment and components of equipment and put together descriptions of the components using “characters” that describe component behavior and transitions and “words” comprising characters that can uniquely describe the sequence of operations of the equipment. The changing power levels of power consumption signals over time may exhibit characteristic signatures for the equipment and components of equipment. The characters may describe these characteristic signatures.

The language may uniquely define characteristic operating signatures of the equipment, as well as components of the equipment. The characters that make up the words of the language may be described as “glyphs” or “runes,” which use a scale-free format modeled after typography. Runes provide a way to describe power consumption signals, e.g., current draw, power, vars, and so on, of a piece of household equipment in a compact and concise format. Runes create a description of behavior and of transitions between behaviors, much like how typography describes letters and text and the transition between letters and text. The language describes how the equipment transitions between events during the sequence of operation. A compiler may use this language to generate programming instructions that may cause processing circuitry to efficiently analyze, identify and monitor equipment, including determining a state of health of the equipment.

In one example, this disclosure describes a method comprising monitoring, by processing circuitry, power consumption signals for an electrically powered equipment unit; sampling, by the processing circuitry, the power consumption signals; sending, by the processing circuitry, the sampled power consumption signal to a server; receiving, from the server, programming instructions that when executed by the processing circuitry, cause the processing circuitry to compare the sampled power consumption signals to the received programming instructions, wherein the received programming instructions comprise data describing an operational cycle for the electrically powered equipment an operational cycle for the electrically powered equipment unit and includes performance boundaries for the power consumption signals; storing, by the processing circuitry, the received data at a memory location operatively coupled to the processing circuitry; comparing the monitored power consumption signals to the received data; outputting an indication of a state of health of the electrically powered equipment unit based on the comparison.

In another example, this disclosure describes a device configured to monitor electrically powered equipment includes receive information from the sensor; store power consumption data at the memory based on information received from the sensor; store data describing an operational cycle for the electrically powered equipment, wherein that data and includes performance boundaries for the power consumption data; compare the power consumption data to the stored data; output an indication of a state of health of the electrically powered equipment based on the comparison.

In another example, this disclosure describes a system configured to monitor electrically powered equipment includes a server comprising first processing circuitry;
a performance monitoring device comprising: a sensor configured measure electrical power consumed by the electrically powered equipment; a memory comprising computer readable storage media; second processing circuitry operatively coupled to the sensor and the memory; the second processing circuitry configured to: receive information from the sensor; store power consumption measurements at the memory based on information received from the sensor; store data describing an operational cycle for the electrically powered equipment, which includes performance boundaries for the power consumption measurements; compare the power consumption measurements to the stored data; output an indication of a state of health to the server of the electrically powered equipment unit based on the comparison.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system configured to monitor and analyze equipment according to the scalable language of this disclosure.

FIG. 2A is a time graph illustrating an example power consumption signature of a variable speed furnace during an operational cycle of the furnace.

FIG. 2B is a time graph illustrating an example power consumption signature of a single stage furnace during an operational cycle of the furnace.

FIG. 2C is a time graph illustrating an example power consumption signature of a two-stage furnace during an operational cycle of the furnace.

FIG. 2D is a time graph illustrating an example power consumption signature of a modulating furnace during an operational cycle of the furnace.

FIG. 3A is a time graph illustrating techniques to identify key transition points in a sequence of operation of an example operational cycle of a furnace.

FIG. 3B is a time graph illustrating determining performance boundaries for an example forced air furnace system according to one or more techniques of this disclosure.

FIG. 4 is a time graph illustrating the use of a first derivative to determine events and transitions during an operational cycle of an example variable speed furnace.

FIG. 5 is a time graph chart illustrating details of an example operation for an ignition system for a furnace, according to one or more techniques of this disclosure.

FIG. 6 is a conceptual diagram illustrating how an aperture window and error limits determine scale for analyzing the signature for equipment according to one or more techniques of this disclosure.

FIG. 7 is a time graph illustrating applying error limits and first derivative information to an example power consumption signature according to one or more techniques of this disclosure.

FIGS. 8A-8D are time graphs illustrating a relationship between scale, error limits and feature identification according to one or more techniques of this disclosure.

FIGS. 9A-9C are time graphs illustrating the effects of scale on comparison and identification of power signatures for a component according to one or more techniques of this disclosure.

FIG. 10A illustrates an example of typography glyph metrics for an example typographical character.

FIG. 10B. is a time graph illustrating an example of applying glyph metrics to a power signature for an ignitor according to one or more techniques of this disclosure.

FIG. 10C is a conceptual diagram that illustrates example runes for an ignitor according to one or more techniques of this disclosure.

FIG. 10D is a conceptual diagram illustrating an example rune according to typography rules for an ignitor.

FIGS. 11A and 11B are conceptual diagrams that apply an example rune to an example characteristic operating signature.

FIG. 12 is a flow diagram illustrating an example operation of a performance monitoring system according to one or more techniques of this disclosure.

### DETAILED DESCRIPTION

In general, the techniques of this disclosure create a language that may describe how any type of industrial or household equipment behaves. In other words, the disclosure describes techniques to define a scalable language to uniquely identify equipment and components of equipment and put together descriptions of the components using “words” comprising characters that can uniquely describe the sequence of operations of the equipment. The changing power levels of power consumption signals over time may exhibit characteristic signatures for the equipment and components of equipment. The characters may describe these characteristic signatures.

The language may uniquely define characteristic operating signatures of the equipment, as well as components of the equipment. The characters that make up the words of the language may be described as “glyphs” or “runes,” which use a scale-free format modeled after typography. These runes may be scaled to represent similar components by a different vendor (a different make/model). e.g., The language also describes how the equipment transitions between events during the sequence of operation. A compiler may use this language to generate programming instructions that may cause processing circuitry to efficiently analyze, identify and monitor equipment, including determining a state of health of the equipment.

The techniques of this disclosure determine scale by using an aperture window. At different scales, the runes may determine different attributes of a component at different levels of detail. At different scales different features may be identified and the features are characterized by goodness of fit based on error limits.

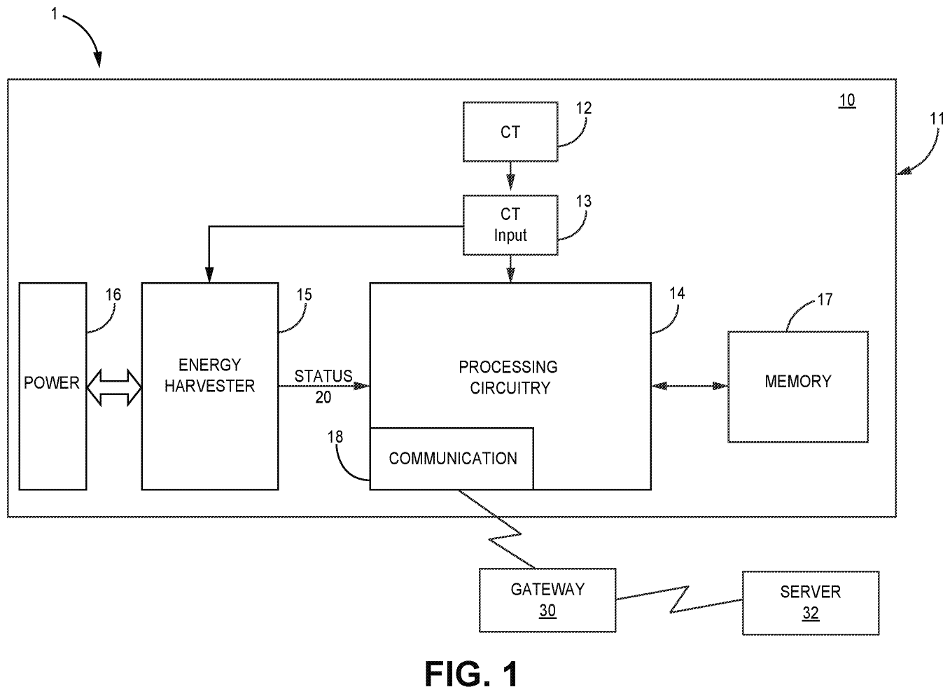

FIG. 1 is a block diagram illustrating an example system configured to monitor and analyze equipment according to the scalable language of this disclosure. The example of FIG. 1 illustrates system 1 including the components of performance monitoring device 10 (device 10 for short) housed in a single housing 11. However, as discussed herein, in different examples device 10 may include multiple housings, with each housing enclosing different components of device 10. Device 10 may be attached to or otherwise coupled to a wire, for example, the power cord, a power wire, or the like, of the equipment. For example, device 10 may be a part of a clamping mechanism that is clamped around the power cord of an equipment. As another example, device 10 may be integrated into a power cord of an equipment, or as a connection interface between the power plug of the equipment and the power socket of a building. The example of FIG. 1 will focus on monitoring performance by measuring power consumption of equipment such as by monitoring electrical current drawn by the equipment. In other examples, the power monitoring device of this disclosure may monitor any power characteristics, including any of the power (watts), voltage-amperes reactive (vars) or electrical current (amperage) over time. In this disclosure power consumption monitoring device 10 may also be described as power monitoring device 10, monitoring device 10, or performance tracking device 10. In some examples, device 10 may be considered an IoT device or IoT performance monitoring device, where IoT is internet of things.

System 1 may also include gateway 30 connected to server 32. Gateway device 30 is a computing device including one or more processors, memory and so on. Gateway device 30 may communicate with device 10, as well as several other similar current monitoring devices connected to other household equipment in a building, such as refrigerator, washing machine, garage door opener, sump pump, pool pump, well pump or other pumps, fans and so on. Server 32 may be an on-site or off-site computing device, such as a cloud computing service.

Device 10 may include housing 11 with current sensing mechanism 12 (CT 12), input component 13 (CT1 input 13), processor 14 (processing circuitry 14), memory chip 17 (OTA flash 17), communication component 18, energy harvester 15, and energy storage unit 16 (battery 16). In this example, the components of the power monitoring device may be integrated into the power plug and the current sensing mechanism may run through the power cord. For example, if the current sensing mechanism is a current transformer, then the current transformer (CT) includes a metal component. In an example where the current transformer is integrated into a power cord or cable, the metal component may be drawn into a thin wire that runs the length or a substantial length of the power cord or cable. This arrangement may allow device 10 to be integrated into standard power cables without significantly increasing the size of the power cord or cable. In other example, device 10 may be integrated into a circuit breaker or fuse with all the components of device 10 integrated into the circuit breaker or fuse. Thus, as the equipment draws power from the main power source, device 10 can identify a current signal as the power is drawn through the circuit breaker. The circuit breaker or fuse may also be integrated into the equipment itself. Similarly, device 10 itself may be integrated into the equipment, for example, not as part of a circuit breaker or fuse.

Device 10 may include a current sensing mechanism 12, which is illustrated in FIG. 1 as a current transformer. However, current sensing mechanism 12 is not limited to a current transformer. For example, current sensing mechanism 12 may be a current transformer, current transducer, Hall effect sensor, resistor, coil, or any other type of current sensing component. Current sensing mechanism 12 may also be referred to as current sensing mechanism 12. Current sensing mechanism 12 may be any type of component or mechanism that can sense or detect electric current traveling through a wire or other power consumption signal. Current sensing mechanism 12 then generates a signal that is proportional to or that corresponds to the current. Thus, current sensing mechanism 12 may be a component that directly senses current or may be a component that senses another electrical characteristic (e.g., voltage, resistance, etc.) and that can convert the detected electrical characteristic to a current measurement.

In the example of FIG. 1, current sensing mechanism 12 is illustrated as being contained within the housing 11. In other examples current sensing mechanism 12 may be separate from housing 11. For example, current sensing mechanism 12 may be attached to a power cord of the equipment and connected to housing 11 via input component 13. In some examples, current sensing mechanism 12 may include a plug (not shown in FIG. 1) and housing 11 may include receptacles, e.g., input component 13 for accepting the plug. In other words, the device 10 may include a plug-and-play interface, e.g., input component 13, that receives one or more plugs from one or more current sensing mechanism. The plug-and-play interface may also be configured to detect the amperage range for current sensing mechanism 12. In some examples, housing 11 may be a waterproof and weatherproof housing suitable for use with outdoor equipment, such as a heat pump, air conditioning unit, circuit breaker, attic fan, pumps at water supply facilities, and other equipment located outdoors. In some examples device 10 may connect to a security system, or components of a security system, to monitor operation and ensure that the security system is operating. In some examples, device 10 may be configured to monitor the operation of an automated teller machine (ATM) or similar equipment to ensure the equipment is working as expected.

Device 10 may include multiple receptacles that could accept plugs from multiple current sensing mechanisms or other sensors. For example, device 10 could receive plugs from more than one current sensing mechanism, thereby allowing a user to have a device 10 that can monitor multiple equipment via the use of multiple current sensing mechanisms 12. Alternatively, other sensors, for example, environmental sensors, microphones, and so on may be plugged into device 10 (not shown in FIG. 1). These additional sensors may provide additional information that can be used by device 10 to detect the state of health of an equipment monitored by device 10.

The plug may include components that can be used to detect a current rating of current sensing mechanism 12. For example, the plug may be similar to a headphone jack which has different contact areas. These contact areas can be utilized to detect different impedances between the components. Electrical current sensing mechanisms having different current ratings would have different impedances between the contact areas. For example, a current sensing mechanism having a current rating of 20 A may be configured with one impedance between the contact areas, while a 40 A current rating would be configured with a different impedance between the contact areas. Different configurations of impedances may be used for different current ratings. For example, different current sensing mechanisms may have 20 A, 40 A, 50 A, 100 A, 400 A, and the like, ratings. Thus, when the plug is plugged into a receptacle of the housing 11, processing circuitry 14 device can identify the current rating for current sensing mechanism 12 based on connections between a subset of impedance components.

Additionally, since the current rating of current sensing mechanism 12 is known, the system can identify if the correct current sensing mechanism is being used for the equipment. In other words, if the equipment has a current rating over the current rating of the current sensing device, the system can identify this mismatch. Upon identification of a mismatch, device 10 may output a signal or an alert, e.g., via communication component 18, indicating that current sensing mechanism 12 is the incorrect mechanism for the equipment. This signal or alert may be as simple as illuminating a light on current sensing mechanism 12 or may be as complex as sending a signal to an information handling device (e.g., smartphone, laptop computer, tablet, smartwatch, etc.) of a user that then results in a notification being displayed on the information handling device (not shown in FIG. 1).

Current sensing mechanism 12 may output a signal is output that corresponds to the current running through the wire. This signal may run through input component 13, (also referred to as receptacles 13 in this disclosure) that allows for part of the signal to be directed to an energy harvester 15. In the example in which current sensing mechanism 12 is separate from housing 11, receptacles 13 may be contained or connected to the receptacle that receives the plug of current sensing mechanism 12. In the case that housing 11 and current sensing mechanism 12 are included in the same housing, receptacles 13 may be a separate component or may be integrated into the energy harvesting hardware mechanism of energy harvester 15. The energy harvester 15 is electrically coupled to current sensing mechanism 12, for example, through the receptacles 13. As a signal is output by current sensing mechanism 12, or by capturing some of the signal input to the current sensing mechanism 12, part of the signal may be directed to the energy harvester 15. In other words, energy harvester 15 draws power from a signal associated with the current sensing circuitry. In the example in which the current sensing circuitry is a current transformer, the signal may be a current generated by the current transformer. In the example of other current sensing circuitry, the energy harvester may be coupled to the signal associated with the current sensing circuitry.

Energy harvester 15 uses this to charge energy storage unit 16. Energy storage unit 16 may be a rechargeable battery or may be another type of component that can store energy. For example, energy storage unit 16 may be a super-capacitor that stores energy. Energy storage unit 16 may be used to provide power to the rest of device 10 circuitry. In some examples, energy storage unit 16 may include a lithium-ion battery for use in cold locations and a nickel-metal-hydride (NiMH) battery for use in hot locations.

Processor 14 receives the signal from current sensing mechanism 12. Processor 14 can be any type of processor, microcontroller, or other type of processing circuitry. Examples of processor 14 may include any one or more of a microcontroller (MCU), e.g., a computer on a single integrated circuit containing a processor core, memory, and programmable input/output peripherals, a microprocessor (μP), e.g., a central processing unit (CPU) on a single integrated circuit (IC), a controller, a digital signal processor (DSP), an application specific integrated circuit (ASIC), a field-programmable gate array (FPGA), a system on chip (SoC) or equivalent discrete or integrated logic circuitry. A processor may be integrated circuitry, i.e., integrated processing circuitry, and that the integrated processing circuitry may be realized as fixed hardware processing circuitry, programmable processing circuitry and/or a combination of both fixed and programmable processing circuitry. Accordingly, the terms “processing circuitry,” “processor” or “controller,” as used herein, may refer to any one or more of the foregoing structures or any other structure operable to perform techniques described herein.

Processor 14 may read the signal from current sensing mechanism 12, e.g., via an analog to digital converter, ADC, not shown in FIG. 1. Processor 14 may also analyze and process the signal to identify characteristics of the equipment based upon the power consumption signal from current sensing mechanism 12. The characteristics may be used to determine if the equipment is performing as expected. If there is a deviation from the expected characteristics of the equipment, the system may determine that the equipment is experiencing an abnormal operating condition. Using analytics, the system may determine what the abnormal operating condition is, for example, whether the equipment or some component is failing. In some examples processor 14 may correlate the characteristics of the received power consumption signal to signals from other sensors, e.g., a temperature sensor indicating that the equipment experiencing changes environmental conditions, a microphone indicating an unusual noise frequency or noise level, or the like. In some examples, a microphone may detect sediment buildup in a tank, such as a water tank, well pressure tank, water softener and so on. In some examples, processor 14 may provide an alert or other notification to a user of the abnormal condition.

In some examples, processor 14 may perform rudimentary analysis of the performance characteristics of the monitored equipment (not shown in FIG. 1), based on the power consumption signal, and input from other sensors. In some examples, processor 14 may upload the power consumption signal to another computing device, e.g., a computing device with more powerful computing capability, such as a server, laptop, mobile device, and so on. Alternatively, rather than device 10 analyzing and processing the signal, device 10 may include a communication component 18, that allows for the signal to be sent to the other computing device, such as gateway 30 or directly to server 32 (not shown in FIG. 1). As shown in FIG. 1, communication component 18 is integrated into processor 14 hardware. However, communication component 18 may be a component separate from processor 14. Communication component 18 may be a wireless communication device, an antenna, a hardware port that allows for a wired communication connection, or the like. Communication component 18 may transmit information associated with the monitored signal to another computing device. The computing device that receives the information from the communication component, for example, a remote computer, gateway device 30, or the like, may then analyze and process the signal. As an alternative, both device 10 and second computing device that receives information may process and analyze the power consumption signal or different portions of the signal. Once the signal has been processed and analyzed, different parameters of the equipment can be identified. This information can then be stored in a data storage location, for example, a cloud data storage location, remote/network data storage location, local data storage location, e.g., memory chip 17, or the like. The stored information may then be used to identify historical trends of the equipment, comingled with information from other equipment to identify geographical trends or parameters of equipment, or the like.

Device 10 may also include other components. For example, device 10 may also include a memory chip 17 (OTA flash 17) for storing data. In FIG. 1 memory chip 17 is identified as an OTA (over-the-air) flash memory chip. However, any type of memory chip or computer readable storage media may be utilized. Memory chip 17 may store firmware updates for processor 14, a subset of historical signals received from current sensing mechanism 12, current firmware for processor 14, or the like. The firmware updates may be provided over-the-air so that device 10 never has to be plugged into another information handling device. Firmware, or software stored at memory chip 17 may include instructions that cause processor 14 to execute the functions described herein. Additionally, memory chip 17 may store some information related to the signals received from current sensing mechanism 12. For example, if device 10 cannot wirelessly connect or loses the connection to the second computing device that the information is being sent to, memory chip 17 may store the signal information until a connection can be made.

The techniques of this disclosure may provide advantages when compared to other techniques. A performance tracking device of this disclosure that receives data describing an operational cycle for the electrically powered equipment in the form of a word comprising a set of characters, or runes, may need only limited processing power and memory 17 to analyze the performance of a piece of equipment. Processing circuitry 14 may decompose the language of the word that describes the equipment and may need to only sample and store a limited number of data points and perform comparison operations between the received runes and measured performance data (electrical current, power, etc.) to determine whether the equipment is operating as expected, or whether there are changes that may need to be reported and investigated further.

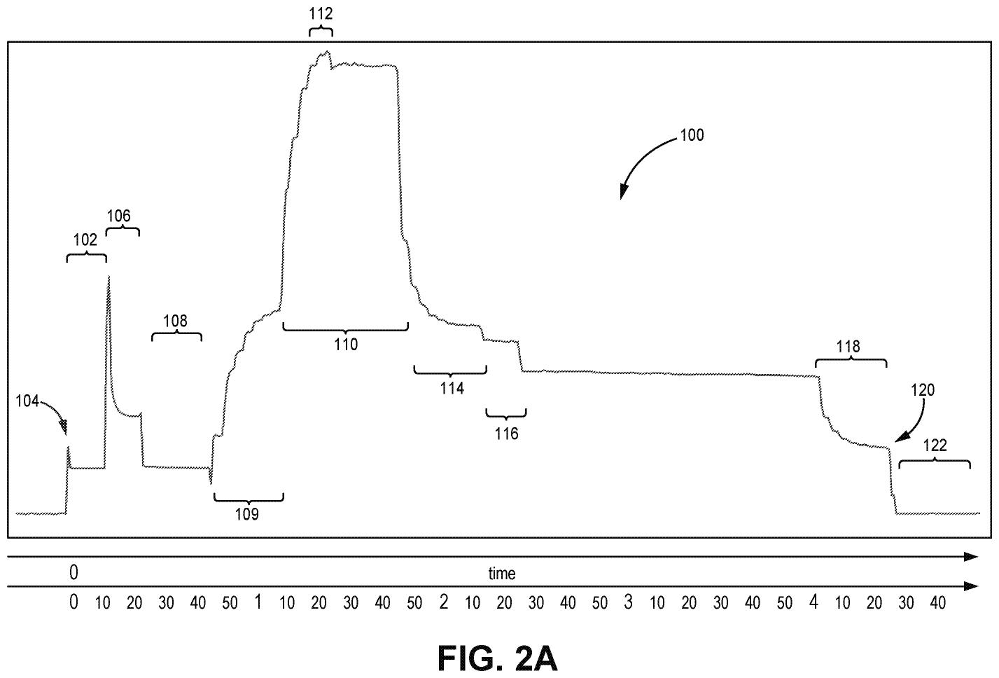

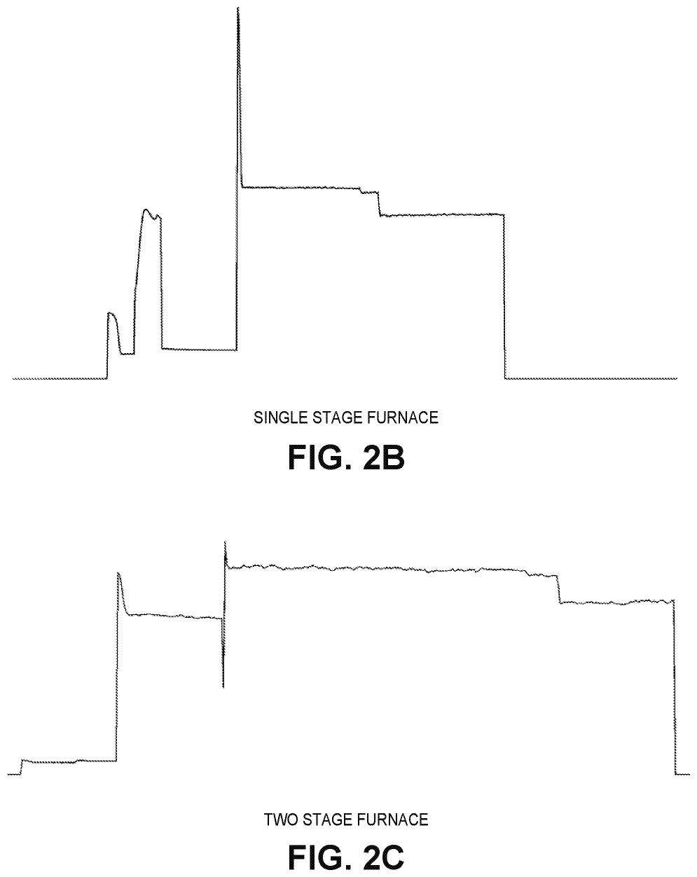

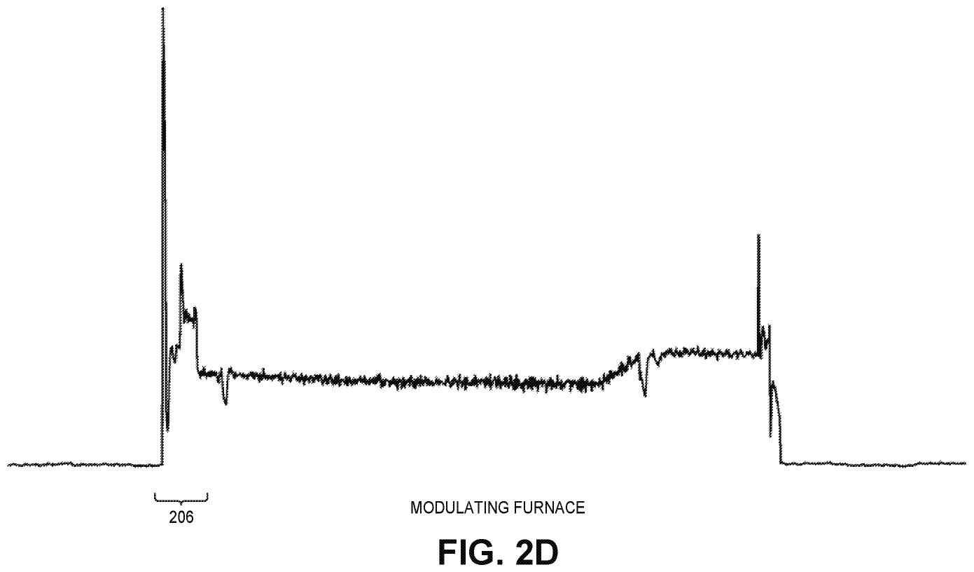

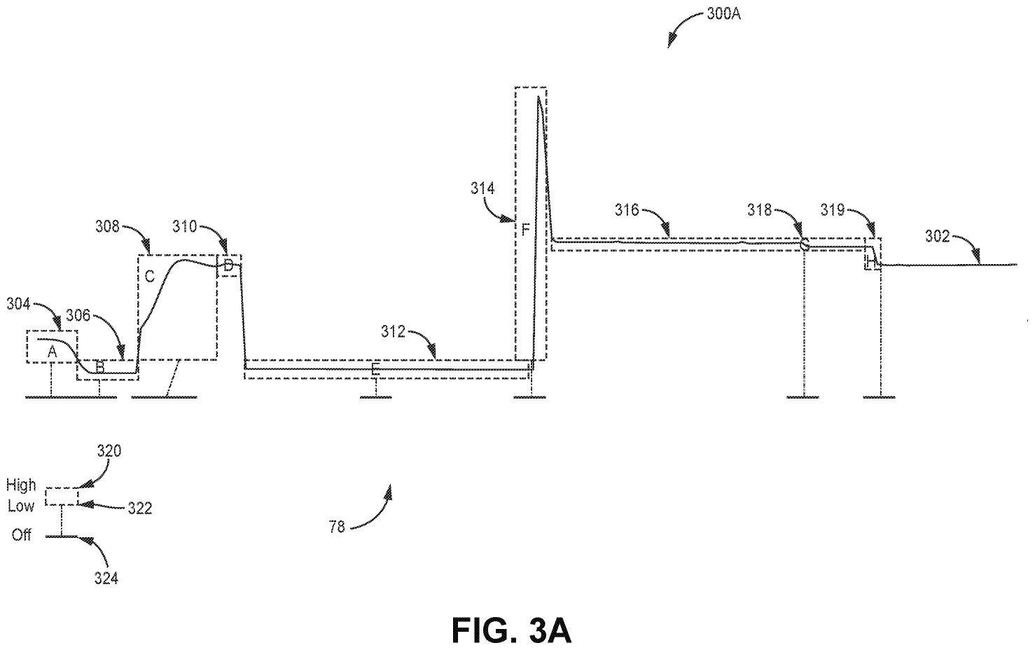

FIG. 2A is a time graph illustrating an example operating signature of a variable speed furnace during an operational cycle of the furnace. In some examples, such as in FIG. 2A, the operating signature may be a power consumption signature or an electrical current draw signature. Operating signature 100 may differ between different types of equipment, with different models or manufacturers of components in the variable speed furnace of FIG. 2A, under different environmental conditions, and whether one or more components of the equipment is functioning properly. Sampling the complex operating signature of FIG. 2A may result in many thousands of data points, which may consume memory storage, as well as consume bandwidth in transmitting the large data set to other computing devices, e.g., from device 10 to gateway 30 and server 32 for storage and analysis. However, the techniques of this disclosure may reduce the data set used to analyze and identify the equipment and therefore reduce memory storage requirements, simplify analysis, and thereby reduce complexity and costs to monitor equipment.

Operating signature 100 includes a power spike at 104 that coincides with an induction blower startup. The furnace may receive a call for heat from a thermostat at approximately time zero, triggering the furnace run. After spike 104, the power settles to steady state value during time period 102, which may indicate the induction blower operation. At the end of time period 102 is another spike in power, indicating an igniter operation. Different type of igniters may show different signatures during time period 106. In some examples a pressure sensor may detect the induction blower operation. A furnace controller may prevent the ignitor from operating until the pressure sensor detects the induction blower. A missing ignitor signature may indicate a faulty pressure sensor, as well as a faulty ignitor.

Also, during time period 106, a gas valve may open, and the furnace flame may start. A flame sensor may detect the presence of heat or flame and the furnace controller may stop the ignitor. During time period 108 the induction blower and furnace flame continue to operate. During time period 109, the circulation blower may start at a low speed. The characteristic shape of the operating signature during time period 109 may help identify the type, manufacturer, model, and correct function of the circulation blower. For example, if the operating during 109 is higher than expected, the circulation blower may have deteriorating bearings or belt slip that cause an abnormal operating signature. By monitoring the operating of the furnace, a monitoring system of this disclosure may detect an impending performance issue and send an alert before the furnace fails. In some examples, an early detection and alert may prevent an expensive service call during off hours such as evening or weekend. In some examples, based on the comparison to expected performance, the monitoring system may be configured to indicate that the equipment, or a component of the equipment, is expected to fail and needs urgent attention.

During time period 110, the circulation blower may increase to a higher speed. Characteristics of the operating signature, such as at 112, may identify the type, model etc. of the circulation blower. At the end of time period 110, the thermostat may indicate the rooms have reached the desired temperature and cease the call for heat. Time periods 114, 116, 118, 120 and 122, depict the operating signature as the circulation blower reduces speed and shuts off, the induction blower turns off and other equipment shuts down to end the furnace cycle.

The techniques of this disclosure may distinguish between a furnace operation, air conditioner operation, heat pump, electric heating unit. A sequence of operations that include an ignitor, gas valve, blower may indicate a furnace operation. A sequence of operation that includes a compressor and a blower may indicate an air conditioner (not shown in FIG. 2A).

FIG. 2B is a time graph illustrating an example operating signature of a single stage furnace during an operational cycle of the furnace. The operating signature for the single stage furnace in FIG. 2B has some similarities as well as identifiable differences from the operating signature of the operating signature for the variable speed furnace in FIG. 2A. The induction blower startup, the ignitor cycle and the circulation blower start-up and shut down are identifiable in FIG. 2B. The signature for the ignitor is different than the ignitor in FIG. 2B, which may indicate a different type of ignitor, or a specific manufacturer.

FIG. 2C is a time graph illustrating an example operating signature of a two-stage furnace during an operational cycle of the furnace. In FIG. 2C, the induction blower start-up is visible on the far left, followed by a first stage and second stage blower starting up, and shutting down at the end of the furnace cycle. The operating signature for the furnace of FIG. 2C does not show an obvious ignitor signature.

FIG. 2D is a time graph illustrating an example operating signature of a modulating furnace during an operational cycle of the furnace. A modulating furnace is a furnace that may slowly ramp up and down in response to changes in the room's temperature, as received from a thermostat or other temperature sensor. In some examples, a modulating furnace may include a modulating gas valve and a variable-capacity blower and when the modulating furnace is initially called into action the furnace may start at the highest flame and blower level possible (206). A modulating furnace may turn on and off frequently than with single-stage furnaces but at lower levels, but by adding heat at lower levels more frequently, the room temperature may be more consistent, when compared to a single-stage furnace. In the example of FIG. 2D, the ignitor operation appears to include some noise during period 206, which is normal for a modulating furnace because other components are turning on during the ignitor phase. In comparison the ignitor operation in FIG. 2A shows little noise during period 106.

Other examples of equipment that an operating characteristic monitoring system, such as system 1 described above in relation to FIG. 1, may include garage a door opener, pumps, such as sump pumps, and so on, as described above in relation to FIG. 1. By monitoring the operational cycle, such as power consumption, cycle time, and so on, a monitoring system of this disclosure may efficiently provide early warning of potential issues by analyzing only a few data points. In some examples, the state of health indication from the monitoring system may indicate a specific failure mode. For example, a garage door opener that shows increased power consumption, or a longer cycle time, may be an indication that the garage door springs are out of adjustment and the garage door opener is working too hard. The monitoring system may notify the owner, or a maintenance service of the potential issue so the springs may be adjusted, before a worm gear, chain or other component of the garage door opener fails and requires an expensive repair. Similarly, a pool pump with an increased power consumption and/or increased cycle times may indicate a clogged filter, debris in the line or some other issue that can be fixed before the pump is damaged. For a furnace, an ignitor with an extended cycle time, e.g., is on for too long, or runs through repeated ignitor cycles for a single furnace run (aka a furnace cycle), may indicate a sticky pilot valve, or sticky main gas valve, which can be repaired before the building gets too cold or the ignitor fails from over-use.

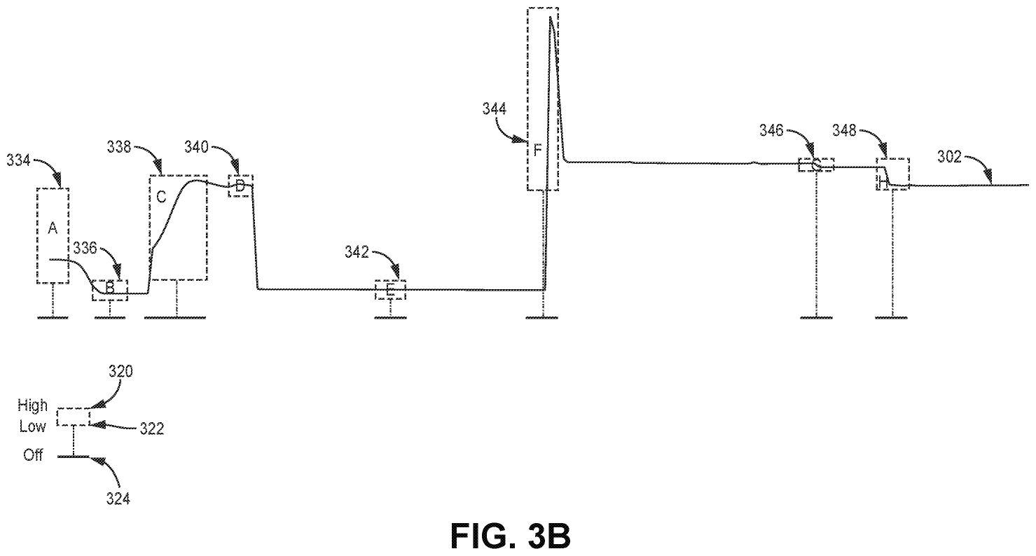

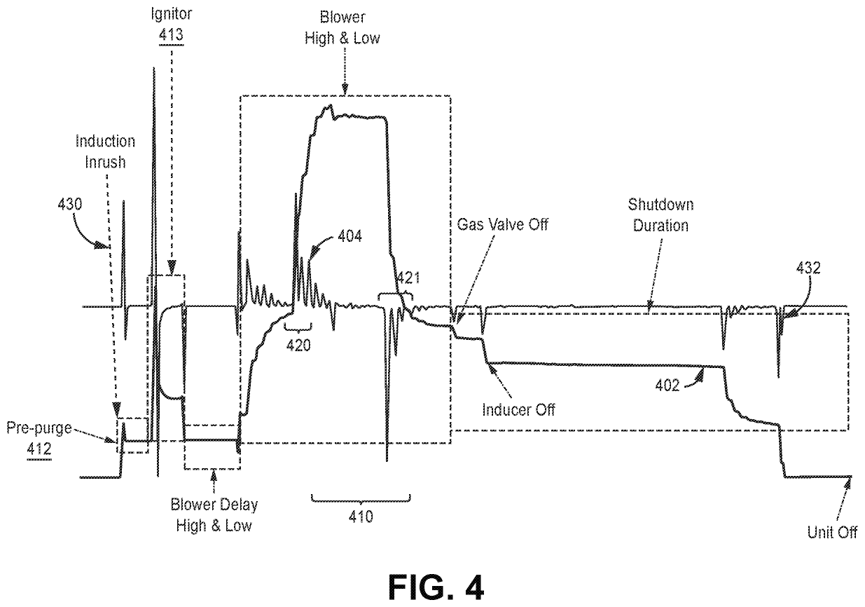

FIG. 3A is a time graph illustrating techniques to identify transition points in a sequence of operation of an example operational cycle of a furnace. In the example of FIG. 3A, time graph 300A describes the operation of an example forced air furnace system. Induction starts at 304 (A), followed by pre-purge 306 (B), and ignition 308 (C). The gas valve turns on during 310 (D) followed by a predetermined delay 312 (E) while the burning gas raises the temperature of the heat exchanger in the furnace. The circulation blower turns on at 314 (F), with a current spike as the motor starts up followed by a steady state electrical current draw, or power consumption, as the furnace provides heated air through the duct system and registers to the spaces within the building. At 318 (G) the processing circuitry of the furnace controller may receive an indication from the thermostat that the temperature sensor read a room temperature that satisfied the temperature threshold, and the furnace controller may cause the gas valve to shut off. At 319 (H) other furnace components may begin to shut down, such as the induction blower.

Each of the transition points in the furnace run may include a maximum or high threshold 320 and a low or minimum threshold 322. A portion of the cycle may also be OFF 324. The value OFF 324 may be set to zero current, or to any current magnitude less than a predetermined threshold value, e.g., 0.2 Amps. In some examples, the performance monitoring system of this disclosure may include a training period in which a performance monitoring device may record several operational cycles, or furnace runs in the case of FIG. 3A. Based on one or more operational cycles, the performance monitoring device may determine the start and stop times and the duration of the transition points, as well as the high and low thresholds.

As described above in relation to FIGS. 2A-2C, each component may have a particular signature. By tracking the current consumption of the system as a whole during the system's sequence of operation, processing circuitry, such as processing circuitry 14 described above in relation to FIG. 1, may identify which components are installed in a particular system. Training the performance tracking device, such as device 10 described above in relation to FIG. 1, may involve marking key transition points in a sequence of operation. The key transition points may define when the system described by time chart 300A moves between stages for the furnace run.

In some examples, an external computing device, such as gateway 30 or server 32 in the system may identify the particular component based on the operating signature and provide the performance monitoring device for the furnace a simplified description, e.g., a rune, of the expected characteristic operating signature. For example, a particular ignitor may have an associated maximum electrical current draw, minimum current draw, and cycle time or duration expected to be operating, along with an expected shape to the current draw curve.

As described above in relation to FIG. 2A, an ignitor may start over a short time, a variable speed blower motor may start with several stages over a long period of time. The individual signatures may identify the component. The processing circuitry may determine, based on the characteristics of the events, e.g., maximum and minimum values, length of time of each event, order of events and so on, that the furnace is a specific model of furnace. Similarly, the processing circuitry may determine whether the furnace includes the expected standard components for that furnace, such as the ignitor, or whether the ignitor has been replaced with a different ignitor, such as a third-party replacement ignitor. For example, furnace may have a particular sequence of operations because of the configuration of the controller board for the furnace. When a blower motor or some other component is replaced with a different manufacturer's part, e.g., carried by a repair technician, the furnace may have a different overall signature than different from other furnaces of the same model and manufacturer.

Similarly, a refrigerator model may have a variety of compressor motors installed. A repaired refrigerator may have a third-party compressor, or a newer model compressor than that originally installed, which may change the operating signature, e.g., power consumption signature from the original signature. In this manner, the techniques of this disclosure, by identifying a system as a collection of components may simplify the issue of equipment identification, even though identification may be more complex because of all the permutations of components.

An advantage of the techniques of this disclosure may include identification and performance monitoring with a reduced data set. In other words, the processing circuitry may compare runs of any length duration using a small number of data points and at different scales. The data points may be defined in a glyph, and the processing circuitry may determine likely fit, e.g., characterize the glyph (aka a rune or letter) to a component. Said another way, defining each component within the equipment as a ‘letter’, the techniques of this disclosure may string ‘letters’, describing components together to make ‘words.’ A performance monitoring device, which may have limited computing power, may receive the ‘word’ associated with the collection of components in the equipment monitored by the performance monitoring device.

In some example, the information downloaded to the performance monitoring device may include expected performance boundaries, e.g., high, low and duration thresholds, e.g., 320 and 322. The performance monitoring device may monitor the system at a local level and only need to communicate to an external computing device that has more computing capability and storage capacity if a sequence has an issue, e.g., measured values within a monitored operational cycle of the equipment outside expected performance boundaries. In other words, the performance monitoring device may compare the monitored ‘word’ to the performance boundaries of the expected ‘word’ to determine the state of health of the equipment. In some examples, the performance monitoring device may only be able to determine that the equipment is not operating as expected. In other examples, the performance monitoring device may determine the type of problem the equipment, or component, is experiencing based on the differences in the monitored signal from the performance bounds. In some examples, the monitoring device may provide an indication of the state of health that includes an indication of a specific type of failure mode for the equipment, e.g., worn, or malfunctioning bearings, insufficient pressure, and so on that may help narrow down the troubleshooting.

The processing circuitry, e.g., of the performance monitoring device, may identify the events 304-318 (A-H) and determine whether the run sequence was as expected or had an issue that may need attention. In this manner a performance monitoring device according to the techniques of this disclosure may output to service organization, e.g., via gateway 30 and/or server 32 depicted in FIG. 1, an alert that one or more components of the monitored equipment may need repair. For example, a repair technician may notify a homeowner that the homeowner's HVAC equipment may need service before the equipment fails.

The techniques of this disclosure may provide advantages over other types of equipment monitoring because the performance monitoring device of this disclosure may be smaller, less complex, and less costly than other types of equipment. The techniques of this disclosure may also provide advantages for large buildings with high-end, extensive analysis and performance tracking. The reduced data set, reduced data transfer and storage, etc. may result in sending, storing, and analyzing reduced data when compared to a detailed sampling of equipment operating characteristics, such as event duration along with start time of each event, ignition start time, blower duration or other characteristics. Thereby reduce the amount of data communicated. Other systems may benefit from the techniques of this disclosure., such as monitoring aircraft equipment, e.g., jet engines, weather radar, and environmental control systems, and other complex systems.

FIG. 3B is a time graph illustrating performance bounding of an example forced air furnace system. The example of FIG. 3B illustrates the current draw of the same forced air furnace system of FIG. 3A. In the example of FIG. 3B, a performance monitoring device of this disclosure may identify the events 334-348 (A-H) and determine whether the run sequence was as expected or had an issue that may need attention. For example, the performance monitoring device may determine, when the value is outside of the high and low values of the performance boundary. In other examples, the performance monitoring device may also determine whether the component timing is within the expected start and end limits of the performance boundaries.

For example, during ignition 338, the igniter may fail to light the flame and the furnace system may re-attempt ignition. The processing circuitry of the performance tracking device may note the repeated ignition and flag the unexpected sequence as a possible issue. The processing circuitry may detect that multiple ignition attempts over several cycles may indicate an imminent component failure. Some example causes for repeated ignition attempts may include that the ignitor may not provide sufficient energy to ignite furnace, the pilot valve may be stuck, the gas valve may be stuck, the solenoid controlling the gas valve may have an issue and may require service, and so on.

In some examples, gateway 30 may receive information from device 10, described above in relation to FIG. 1, that is connected to the furnace of FIG. 3B. Processing circuitry of gateway 30 may execute an algorithm to create the ‘word’ or ‘letters’ based on the signal from device 10 connected to the equipment. In some examples, gateway 30 may compare the monitored power signals to the received data describing an operational cycle for the electrically powered equipment in the form of a word, by parsing the electrical signature into predetermined portions and identify a respective rune of the runes comprising the word, corresponding to each respective predetermined portion. Gateway 30 may then compare power signals to the ‘letters’ or ‘words’ and if the comparison shows the power signals are different from the expected, as defined by the runes, gateway 30 may send information to server 32, e.g., connected to the cloud. In some examples, gateway 30 may not try to interpret the signal, but rather simply applies an algorithm and if different than the downloaded ‘words/letters’ gateway 30 sends the data to the cloud. In this manner, the monitoring process may reduce the complexity to a simple pattern match on gateway 30.

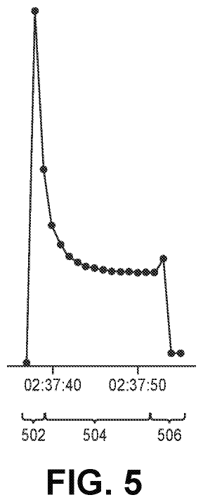

FIG. 4 is a time graph illustrating the use of a first derivative to determine events and transitions during an operational cycle of an example variable speed furnace. By calculating a first derivative, processing circuitry of this disclosure may determine whether there is a transition in the operational characteristic and whether the change is an increase or a decrease.

An example of a derivative is to subtract the value of a point in time from the value at the previous point in time. If the derivative is positive, a component may be turning on. If the derivative is negative, a component may be turning off. By calculating a derivative of value, e.g., amperage, vars, power, etc., the processing circuitry may determine events that identify a turn on and turn off of a component. As with FIGS. 1-3B, the description of FIG. 4 will focus on amperage to simplify the description.

The example of FIG. 4 shows a furnace run 402 of a variable speed furnace superimposed with a first derivative 404 of the same furnace run. As the furnace controller receives a call for heat from a thermostat, or similar sensor, the controller may start the induction blower for the pre-purge stage 412. Starting a motor may result in a current spike as power is applied to the motor coils, which may further result in an indication of an induction inrush current 430 in the first derivative curve. The sharp increase in electrical current draw when the ignitor starts 413, results in another spike in the first derivative.

In the example of FIG. 4, during time period 420, the circulation blower motor shows a large, positive first derivative peak, followed by several smaller positive first derivative values. Therefore, during time period 420 the blower was in the state of turning on. During time period 421, the blower motor shows a large negative first derivative peak, followed by smaller negative first derivative values. Therefore, during time period 421, the blower was in the state of turning off. The processing circuitry may determine, based on the first derivatives, how long and at what power level, the blower motor turned on. Similarly, the processing circuitry may determine each power level change and for how long the blower motor turned off during period 421. The time between the positive first derivative peaks and negative first derivative peaks may provide an indication of how long the circulation blower was running for this furnace operational cycle. Time period 432 shows additional negative first derivative spikes as other components of the furnace shut off, e.g., the gas valve, induction blower (inducer) and other components.

As described above in relation to FIGS. 3A and 3B, a particular type of blower motor (induction circulation or other blower) may have a particular signature. Using the first derivative of value may be one technique to determine the signature for the blower motor and determine which type, and in some examples, the manufacturer of the blower motor.

Tracking the time and magnitude of the first peak and the time the first derivative returns to steady state may provide a benefit in reducing the number of data points in the performance data used to determine component performance. In other examples, any single point in the signature, or combination of points may be substituted for the first peak. The processing circuitry may not need to track and store the current magnitude at each sample time. In other words, processing circuitry may ignore the points in between peaks of the derivative, but still have enough information to analyze the performance of a component, including whether the component is performing within expected tolerances, as described above in relation to FIGS. 3A and 3B.

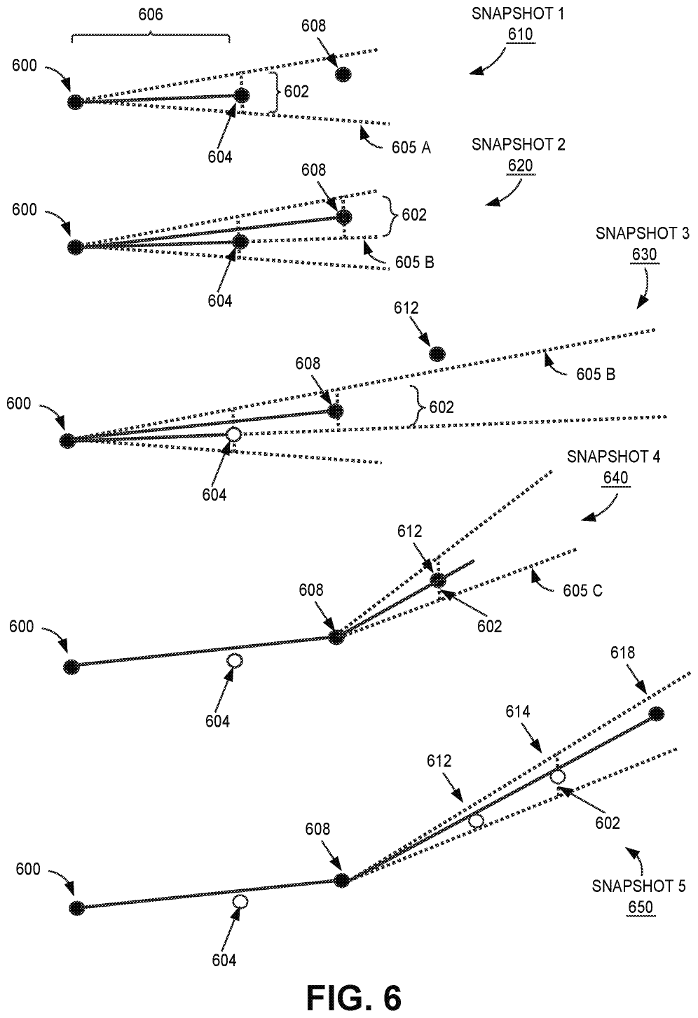

FIG. 5 is a time graph chart illustrating details of an example operation for an ignition system for a furnace, according to one or more techniques of this disclosure. As described above in relation to FIG. 3A, the first derivative information may provide transition information for the operating characteristics. For example, processing circuitry of this disclosure may calculate the rate of change at by calculation the difference in the sampled data at time Tn+1−Tn to identify when a component turns on and off. Some on/off events are nearly instantaneous occurring in an interval of one second or less. Other events may ramp up or down over time. In the example of FIG. 5, Ignitor ON 502 is an event lasting approximately one second. Ignitor Running 504 is an approximately fifteen second event. The duration for ignitor off 506 is similar to that for ignitor on 502.

The table below includes a detailed sampling of data for the ignitor operating signature of FIG. 5.

| | | Rate of Change | Noise | ABS(RoC) > | On Off | |
|---|---|---|---|---|---|---|
| Time Stamp | Amps | (RoC) | Filter | Noise Filter | Event | Duration |
| 02:37:37Z | 0.4967 | | | | | |
| 02:37:38Z | 1.9892 | 1.4925 | 0.04 | TRUE | 1.4925 | 1 |
| 02:37:39Z | 1.3202 | −0.669 | 0.04 | TRUE | −1.0386 | 4 |
| 02:37:40Z | 1.0837 | −0.2365 | 0.04 | TRUE | | |
| 02:37:41Z | 0.9999 | −0.0838 | 0.04 | TRUE | | |
| 02:37:42Z | 0.9506 | −0.0493 | 0.04 | TRUE | | |
| 02:37:43Z | 0.9248 | −0.0258 | 0.04 | FALSE | | |
| 02:37:44Z | 0.9089 | −0.0159 | 0.04 | FALSE | | |
| 02:37:45Z | 0.8992 | −0.0097 | 0.04 | FALSE | | |
| 02:37:46Z | 0.8928 | −0.0064 | 0.04 | FALSE | | |
| 02:37:47Z | 0.8881 | −0.0047 | 0.04 | FALSE | | |
| 02:37:48Z | 0.8853 | −0.0028 | 0.04 | FALSE | | |
| 02:37:49Z | 0.8852 | −1E−04 | 0.04 | FALSE | | |
| 02:37:50Z | 0.8825 | −0.0027 | 0.04 | FALSE | | |
| 02:37:51Z | 0.882 | −0.0005 | 0.04 | FALSE | | |
| 02:37:52Z | 0.9404 | 0.0584 | 0.04 | TRUE | 0.0584 | 1 |

To describe the full shape of the ignitor characteristic operating signature. As described above in relation to FIG. 3A, transition points such as the on/off events may reduce the number of points of interest. Combining non-instantaneous events may further reduce points of interest. The processing circuitry may also track of the duration, e.g., the time interval between the ON event and the OFF event, which may provide further information about equipment performance. An example technique to reduce transition points by combining non-instantaneous events may include a linear predictor technique which may use an aperture window and error limits.

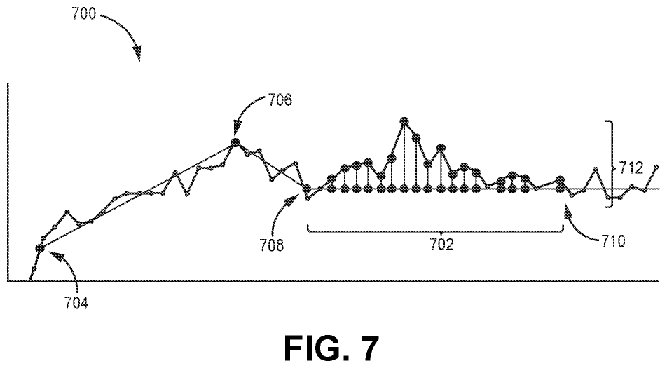

FIG. 6 is a conceptual diagram illustrating how an aperture window and error limits determine scale for analyzing the signature for equipment according to one or more techniques of this disclosure. Processing circuitry may combine the first derivative analysis that may determine on/Off event points of interest with linear predictor techniques that apply an aperture window with an error limit 602 to compress signal to a smaller number of points to be recreated later. In this disclosure, error limit 602 may also be described as error band 602.

The example of FIG. 6 describes an example linear predictor technique. As shown in FIG. 6, new data points may be predicted by recursively extrapolating a line connecting a previous two data points. In this manner, the linear predictor technique may reduce the number of data points that need to be saved to reconstruct, for example, the ignitor signature described above in relation to FIG. 5. A large error limit may result in fewer data points saved but may lose some details of the operational behavior, as shown by the power consumption signature, of the equipment being monitored. Therefore, selecting the error limit may be based on a trade-off between the level of detail needed for the desired analysis and costs associated with transmission, processing, and storage of data points.

Snapshot 610 through snapshot 650 of FIG. 6 depict a linear predictor technique to save or discard datapoints as time progresses. In snapshot 610, (depicted as snapshot 1 610 in FIG. 6) processing circuitry may collect a first sample 600 at a first time. After a sampling interval 606, processing circuitry may collect a second sample 604A and draw a line between sample 600 and sample 604A. Error limit 602 at the sample time of sample 604A determine an aperture window, indicated by dashed lines 605A. Selecting different values for error limit 602 will increase or decrease the size of aperture window 605A, and therefore impact future data points that fall within aperture window 605A. In some examples the size of error limit 602 may be described as ±dy, or 2dy, where dy is the amount along a y-axis of the time graph from sample 604A to the top and bottom of error band 602.

Snapshot 610 also includes sample 608 which falls within aperture window 605A. As shown in snapshot 620, because sample 608 falls within aperture window 605A, processing circuitry may generate a new line between sample 600 and sample 608 and discard sample 604. Processing circuitry may apply error limit 602 to sample 608 in snapshot 620 to generate a new aperture window 605B.

Processing circuitry may extrapolate sample 604 during reconstruction of the time graph. Both the line between sample 600 and sample 604, and the line between sample 600 and sample 608 fall within aperture window 605B. The linear predictor technique of FIG. 6 is based on the assumption that any point within the aperture window is on an approximately straight line from the first point, e.g., sample 600, within error limit 602. The processing circuitry may then save the first and last point, e.g., 600 and 608 and skip the middle point, e.g., sample 604. In this manner the linear predictor technique may reduce the number of saved data points but lose little information about the time graph.

The processing circuitry may recursively proceed through the sampled data points of the time graph. Snapshot 630 includes new sample 612, taken after the next sampling interval from sample 608, which falls outside of aperture window 605B. According to the linear predictor technique, the processing circuitry may save sample 608, draw a new line between sample 608 and sample 612 and apply error limit 602 to sample 612 to generate aperture window 605C, as shown in snapshot 640. Discarded sample 604 is shown as an open circle.

As shown in snapshot 650, the processing circuitry may continue along the time graph for each data point at the sample interval, applying error limit 602 to confirm the aperture window and discarding data points that fit within the aperture window, as shown by the open circles for samples 612 and 614. In this manner the linear predictor technique may represent time graph defined by the six data points 600-618 with only three samples 600, 608 and 618, e.g., a fifty percent data savings.

In other examples, a larger error limit 602 may create an aperture window that includes samples 612-618 in the original aperture window that originates from sample 600. The larger error limit may allow the processing circuitry to represent the time graph of FIG. 6 with only two data points, e.g., samples 600 and 618. However, the larger error limit would lose the information of the bend in the time graph at sample 612. In some examples, processing circuitry calculate the error between each point in the output (after the linear predictor is applied) to determine how good a ‘fit’ the line is for the actual graph. If the ‘fit’ has a low enough error, the algorithm of this disclosure executed by the processing circuitry may determine that the resulting reduced data set is a match.

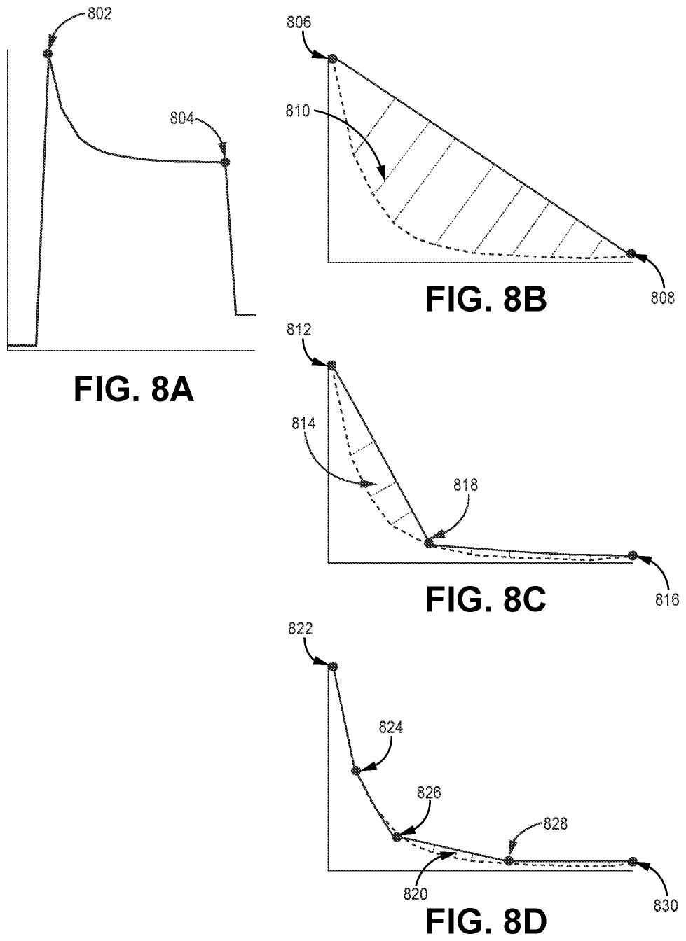

FIG. 7 is a time graph illustrating applying error limits and first derivative information to an example operating signature according to one or more techniques of this disclosure. As described above in relation to FIG. 6, the processing circuitry may apply the linear predictor, or similar algorithm, and calculate the error between each point in the output. If the output ‘fit’ has a low enough error, the algorithm of this disclosure executed by the processing circuitry may determine that the resulting reduced data set is a match.

In the example of graph 700, to determine the contours of the operational signature between 704 and 710 may result in a data set including 200+ data points. However, these first 200+ data points may be represented by four data points 704, 706, 708 and 710. The horizontal line during time period 702 does not have a first derivative that may indicate a turn-on or turn-off event. However, the first derivative of data points on graph 700 between the saved data points 704, 706 and 708 may indicate a slope, which defines a turn-on and/or turn-off event, as described above in relation to FIG. 5. The processing circuitry may check the errors along the approximately horizontal line between 708 and 710 and set error band 712.

When measuring the operating signature, which in the example of FIG. 7 is a power consumption signature, the processing circuitry may vary the window size of the linear predictor. At a large window size, the output data file may lose detail but still be able to calculate the error to understand if the fit is enough to understand whether the reduced data set defines enough detail in operating cycle to identify the equipment, and/or determine whether the equipment is operating as expected. According to the techniques of this disclosure, the window size may correlate to the font size of a rune (also described as a glyph) that describes the operating characteristic. As the processing circuitry that executes the algorithm of this disclosure reduces the scale, the processing circuitry may record more data points, but also results in a reduced error indicating that the reduced output data is a match for the characteristic operating signature. In other words, the window size may allow the processing circuitry to control the ‘font size’ at different scales (having different associated error limits) to see quickly if the output data is a ‘match’ for the measured operating signature.

The four data points 704-710 may be at a mid-scale and accurately enough represent the performance of the component to analyze time graph 700 to determine the type and model of component and whether the component is performing within performance boundaries. The techniques described for FIG. 7 may also be applied to the furnace run depicted in FIG. 4. At a very large error band, the entire performance profile of the furnace run depicted in FIG. 4 may be compressed into the start time 430 and end time 432, which may be enough to determine whether the events constitute a furnace run, and whether the furnace run is within an expected time tolerance.

In some examples, the processing circuitry may decrease the error band window to zoom in on more detail. At a first zoom level, the narrower error band window may increase the number of sampled points from just the start and end to several intermediate points that may be enough to determine other events, such as ignition, blower start and end times and so on. At a more detailed zoom level, the error window may be such that the processing circuitry may determine whether the components operated within the expected maximum and minimum current magnitude and for the expected amount of time. In this disclosure a more detailed zoom level may be considered a smaller scale and provide more detailed resolution of equipment operating performance. By combining identification of the first derivative along with a data point reduction technique, such as the linear predictor, the performance monitoring system of this disclosure may identify equipment type (motor, compressor, ignitor, etc.), manufacturer, model and so on. The performance monitoring system may retrieve stored expected operating signatures or learn the operating signatures by monitoring normal equipment operation and compare actual operation with expected operation to determine the state of health of the equipment, or components of the equipment. The performance monitoring system of this disclosure may provide advantages over other types of monitoring systems by using the first derivative and, for example, the linear predictor, to identify and monitor equipment using significantly less data storage and data transfer when compared to other types of monitoring systems.

The performance monitoring system of this disclosure may be configured to collect data at various scales and output different levels of data. In some examples, the processing circuitry may be configured to report each furnace run, and any specified level of detail regarding the furnace run, e.g., via communication circuitry 18 as described above in relation to FIG. 1. In other examples, the processing circuitry may report only that the furnace run occurred and was within duration tolerances and/or power consumption tolerances. In other examples the processing circuitry may only report a furnace run when the processing circuitry detects one or more anomalies, e.g., a component out of performance bounds, or a furnace run with two or more ignition events, and so on.

As described above in relation to FIG. 6, analyzing the power consumption signature at different scale levels may provide more or fewer features in the power consumption signature. In the examples of FIGS. 2A and 2D each time graph depicts an ignitor operation during time periods 106 and 206. In the example of FIG. 2D, the ignitor operation appears to include some noise during period 206 while the ignitor operation in FIG. 2A shows little noise during period 106. The ignitors of FIGS. 2A and 2D may be the same type of ignitor. However, because the modulating furnace of FIG. 2D draws current to perform other tasks during operation, a performance monitoring device may detect what appears to be noise during the ignitor phase of operation, which is normal for the modulating furnace. However, a similar noisy signature during period 106 on the furnace of FIG. 2A may indicate that the ignitor is malfunctioning. A performance monitoring device on the furnace of FIG. 2A may zoom in to a small scale to get the higher resolution needed to detect noise on the ignitor. At a large scale, the ignitor performance of both the furnace of FIGS. 2A and 2D may appear to be the same.

Similarly, a performance monitoring device, such as device 10 depicted in FIG. 1, connected to a refrigerator may be configured to report a defrost cycle, a compressor run or other operations of the refrigerator at any level of detail. In other examples, a performance tracking device connected to a garage door opener may be configured to report only when a door open or door close cycle is outside of performance bounds. For example, an increase current draw may indicate that the door is binding, or the springs need to be adjusted. In this manner, a performance monitoring device of this disclosure may provide a benefit of early warning that maintenance may be needed before the equipment is damaged, e.g., the garage door opener motor burns out, strips a gear or other damage.

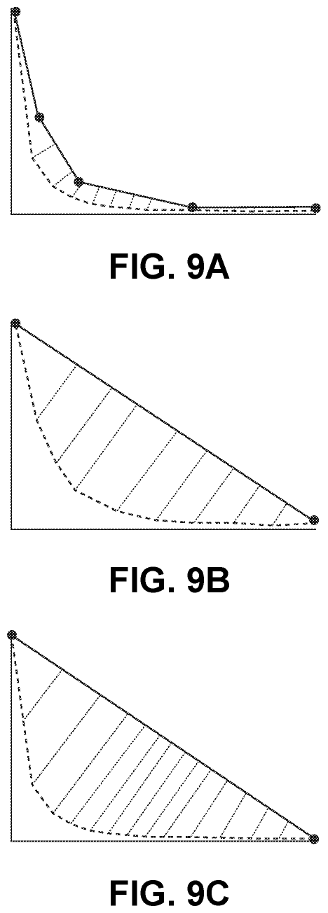

FIGS. 8A-8D are timing graphs representing an example performance of an ignition system for a furnace, similar to the ignitor described in relation to FIG. 5. At a large scale, the operating performance graph of FIG. 8B between points 806 and 808 may represent the graph of FIG. 8A, as long as the error level 810, aka error window 810 provides enough discrimination for the desired analysis of FIG. 8A between points 802 and 804. In some examples, a large-scale data output may be useful when the desired analysis may just be whether or not the ignition system activated.

With a smaller error level 814, e.g., smaller scale, FIG. 8B may provide higher resolution at the cost of an increase in the number of data points: 812, 818 and 816. The graph of FIG. 8B may provide a higher confidence level, e.g., 90%, when compared to FIG. 8A, which may provide a confidence level of, for example 80%.

Decreasing the scale further, error level 820 may provide a higher confidence level, e.g., 99%, at the cost of more data points: 822, 824, 826, 828, and 830 to represent the operation of the ignitor of FIG. 8A. In this manner the techniques of this disclosure may compress the data from, for example, a high number of points to only a few data points as needed to perform the desired analysis. For example, the scale of FIG. 8B may be sufficient to determine whether the ignitor of FIG. 8B is within the performance bounds of maximum current, duration and so on. Processing fewer data points may increase speed, reduce required communication bandwidth, and simplify calculations. A higher resolution may provide additional detail as needed.

As depicted in FIGS. 2A-2B, the ignition systems may all have an expected maximum current, minimum current and duration while operating. The techniques of this disclosure may represent any of the large number of available ignition systems by the operating signature of the ignition system. Processing circuitry of the performance tracking device of this disclosure may use the operating signature at a scale appropriate to the desired analysis task, e.g., to discriminate between different types of ignition systems, as well as determine any operational variability that may be outside expected performance bounds.

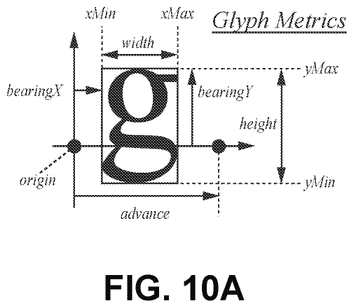

FIGS. 9A-9C are time graphs illustrating the effects of scale on comparison and identification of power signatures for a component according to one or more techniques of this disclosure. The characteristic operating signature of FIGS. 9A and 9C are the same, while FIG. 9B is different. At a larger scale FIG. 9C may not be distinguishable from FIG. 9B. In some examples, such as when determining only whether the ignitor operated, the larger scale analysis may be enough. In other examples, such as when performing an identification, the smaller scale of FIG. 9A, with a larger output data set, may be desirable.

In some examples, the indication of the state of health may include an indication that a first component of the electrically powered equipment associated with data describing an operational cycle for the electrically powered equipment in the form of a first rune was replaced by a second component. For example, an ignitor, a compressor on a refrigerator, and so on may be replaced as ongoing maintenance, or when as needed for repairs. In some examples, the first component is the same type of component as the second component, and the second component may perform the same function as the first component. Therefore, a performance monitoring device of this disclosure, e.g., device 10 described above in relation to FIG. 1, may be configured to receive updated data describing the operational cycle, e.g., in the form of a word made up of runes describing the equipment performance. The updated word may include a second rune to replace the first rune in the updated word, and the performance monitoring device may perform future comparisons using the updated word.

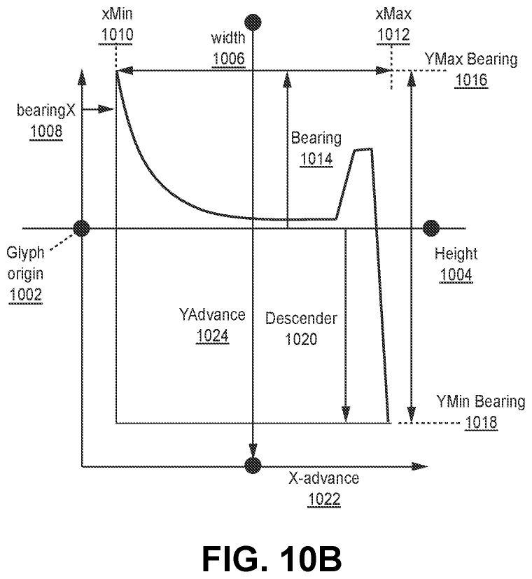

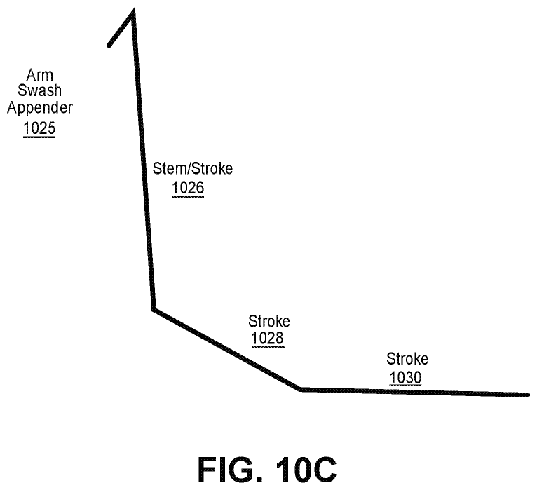

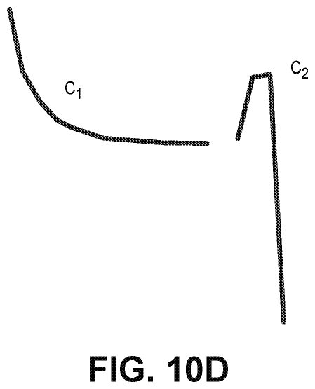

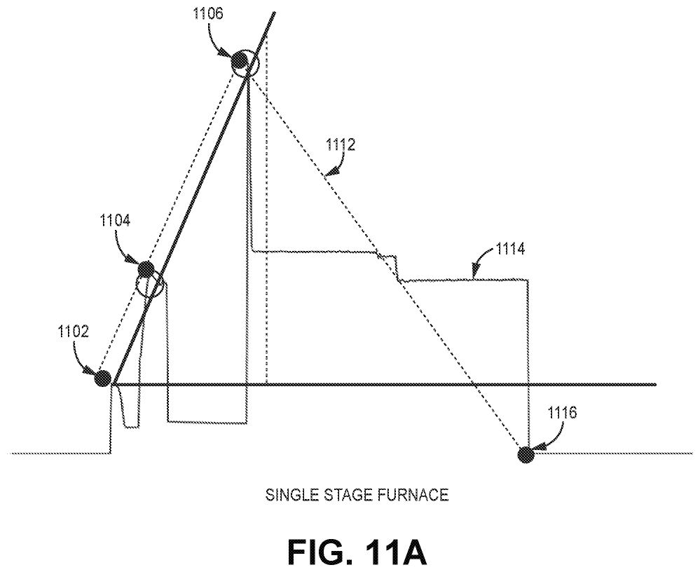

FIG. 10A illustrates an example of typography glyph metrics for an example typographical character. In the example of FIG. 10A, the character is a lower case English letter “g.”

Similarly, the runes (also called glyphs) of this disclosure are based on typography and scale. Typography is a language to describe a character. For example, the English letter “C” can be identified as the letter C at small scale, e.g., a 4-point font, and at large scale, e.g., 400-point font and any scale in between. Typography also defines the how a letter combines with a previous letter and a following letter. In other words, for a given language, the transition between one letter and the next letter may be well defined. The letter C in a font library may look different between different fonts, but may still be identifiable as the letter C. Similarly, by looking at a letter C, a trained observer may be able to determine the font of that letter C.

Similarly, any piece of equipment has a sequence of events in which a component runs and transitions to the next component, or next operation of the same component. As described above in relation to FIG. 2A-2D, a component may have a characteristic signature. For example, a silicon nitrate (SiN) ignitor may have a surging spike followed by a gradual drop, followed by a sharp drop as the ignitor shuts off. However, a first SiN ignitor may differ in the specific details of the characteristic signature, e.g., the maximum magnitude of the first spike, the timing between the start and shut off, the slope of the gradual drop, and so on. By observing the characteristic signature, a trained observer may determine the type of ignitor, e.g., SiN or some other type, the specific model of SiN ignitor, and whether the SiN ignitor is performing as expected.

The techniques of this disclosure provide for an analysis of the characteristic signature for each component of equipment by describing the characteristic as a rune. Once the language is defined, a component may be assigned to any character, or rune. The performance of the component may be analyzed at any scale. As described above in relation to FIGS. 8A-9C, different characteristics of a figure may be visible based on the scale. The scale may also be described as the zoom level. As one example, everything may appear flat at infinite scale.

As illustrated by the furnace run in FIG. 3A, a rune may represent a transition, which is when a component starts, stops, or start and runs for a programmed time duration. In some examples, induction 304 is a sequence of a start and a predefined pre-purge window 306, ignition is a start and a programmed time window before the gas valve runs. The gas valve starting is a transition that includes the gas valve 310 but also the igniter turning off. In some examples, a rune may include 304 and 306 as separate runes. In other examples, a rune may include one rune with both 304 and 306 depending on the equipment type. In some examples, some transitions are fast transitions in which a single rune for the transition may be desirable.

In this manner, the performance monitoring device of this disclosure may receive a rune that includes performance bounds, e.g., duration, maximum and minimum expected current magnitude. With this rune, the performance tracking device may have enough information to determine whether a component of the equipment is operating as expected and whether the performance has changed. In some examples, equipment may have a complex operating cycle that may require two or more runes to describe the operation. In this disclosure, combining runes may result in a “word” to describe one or more operational cycles for equipment. With a “word” comprising a series of runes, the performance tracking device may determine whether an operational cycle of household equipment, e.g., a furnace run, geothermal heat pump operation, defrost cycle, garage door open/close cycle and so on, are performing as expected.

As described above in relation to FIG. 3, the techniques of this disclosure may reduce the complexity to simple pattern matching. In this manner, the processing circuitry in the performance monitoring device, e.g., device 10 described above in relation to FIG. 1, may be a low cost, basic processor configured to perform basic pattern matching analysis, communication tasks and so on. In this manner the performance monitoring device may be small, compact, lightweight and low cost allowing a user to purchase multiple performance monitoring devices for multiple pieces of household equipment. Similarly, gateway 30 may perform pattern matching and need not include an expensive processor requiring expensive heat dissipation and power consumption requirements. More complex analysis may be offloaded to a server, such as a workstation or laptop in the building, or off-site. For example, the characteristic operating signature described above in relation to FIG. 7 may be analyzed using only four data points, e.g., 704-710, rather than analyzing the hundreds of possible datapoints to sample the details of the operational cycle.

FIG. 10B. is a time graph illustrating an example of applying glyph metrics to a power signature for an ignitor according to one or more techniques of this disclosure. The techniques of this disclosure describe components of a system using a language like typography that uses connectivity standards and scale to describe any piece of equipment. The example of FIG. 10B may correlate to portions 504 and 506 of the operational cycle of the ignitor described above in relation to FIG. 5.

The description of the rune starts at the glyph origin 1002. The rune starts at xMin 1010 with bearingX 1008 and bearingY 1014 measured from glyph origin 1002. Other descriptive elements may include Yadvance 1024, Xadvance 1022, Ymax bearing 1016, Ymin bearing 1018 and height 1004. The rune of FIG. 10B also includes a descender 1020. Other glyph elements may include legs, joints and so on.

FIG. 10C is a conceptual diagram illustrating an example rune according to typography rules for an ignitor. The rune in the example of FIG. 10C may describe a portion of an ignitor characteristic signature such as the ignitors described above in relation to FIGS. 5 and 10B. Some portions of the run of FIG. 10C may be described as an arm swash appender 1025, a stem or stroke 1026, as well as strokes 1028 and 1030.

FIG. 10D is a conceptual diagram that illustrates example runes for an ignitor according to one or more techniques of this disclosure. In some examples, the operating signature of a component, such as an ignitor, may be described with a single rune. In other examples, a component may be described by a word that includes multiple runes, e.g., C1 and C2 in FIG. 10D. In some examples, the operating signature could be described by one simple rune to detect if the run is good and described by a more complex or by multiple runes to detect whether the components have changed. In other examples, a single rune or word of multiple runes at different scales may describe the operating signature as described above in relation to FIGS. 8 and 9. That is, a small scale of the word may describe details of the operating signature while a large scale may define just specified transition points

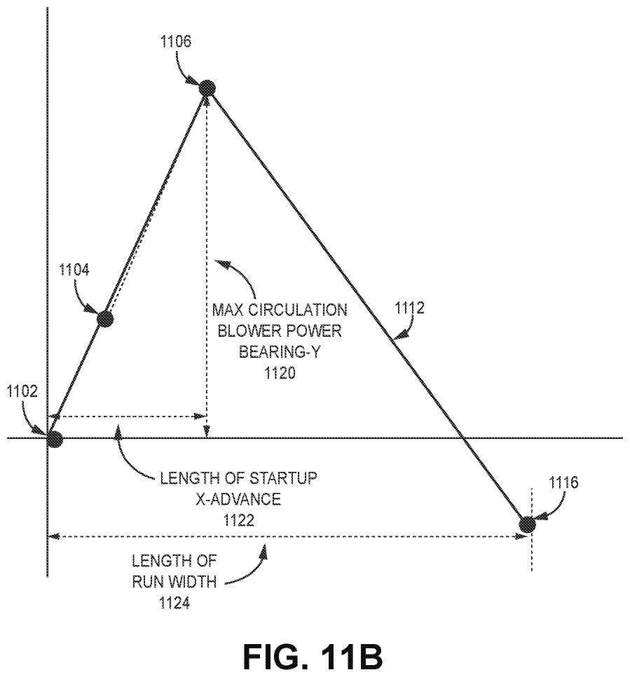

FIGS. 11A and 11B are conceptual diagrams that apply an example rune to an example characteristic operating signature. FIG. 11A includes an operating signature 1114 for a single stage furnace, similar to that described above in relation to FIG. 2B. By applying a first derivative and linear predictor to the operating signature, as described above in relation to FIGS. 4, 6 and 7, processing circuitry of this disclosure may describe the furnace run of 1114 with four points 1102, 1104, 1106 and 1116. The points induction blower start time and magnitude 1102, the ignitor start time and magnitude 1104, the circulation blower start time and magnitude 1106 and the end of the furnace run 1116. The four points may define a shape or rune 1112. In this manner, the four points that define rune 1112 describe whether the ignition system, inducer and blower are in tolerance for electrical current draw, and if the timing of each transition point indicates a good sequence of operations. The furnace run may have been many seconds longs with thousands of points, but the performance monitoring system of this disclosure only needs the four transition points to determine if the furnace run is good or bad.

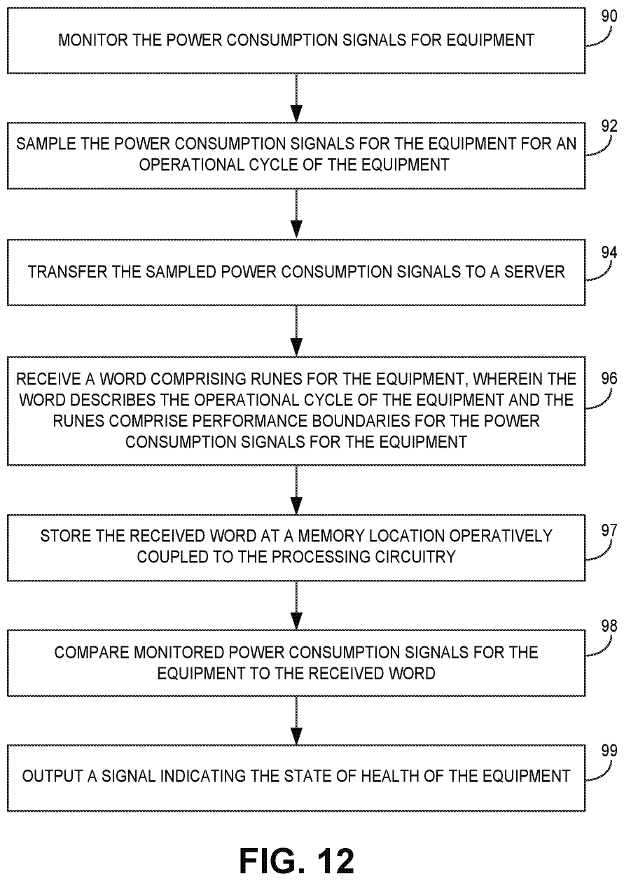

FIG. 12 is a flow diagram illustrating an example operation of a performance monitoring system according to one or more techniques of this disclosure. The blocks of FIG. 12 will be described in terms of system 1, described above in relation to FIG. 1, unless otherwise noted. In some examples, a performance monitoring device according to the techniques of this disclosure may analyze a run, aka an operational cycle, determine which components, download to the performance monitoring device the components in the system being monitored, along with expected performance boundaries.

Processing circuitry 14 of performance monitoring device 10 may monitor one or more operating characteristics, such as power consumption signals for an electrically powered equipment unit (90). Examples of electrically powered equipment units may include household equipment, such as a furnace, sump pump, refrigerator and so on. Electrically powered equipment units may include one or more components, and each component may have operating characteristics. In some examples, device 10 may include a clamping mechanism, such as a current transformer, that is clamped around the power cord of the electrically powered equipment unit and be configured to measure the magnitude changes in current passing through the power cord.

Processing circuitry 14 may sample the power consumption signals to identify and monitor the performance of the electrically powered equipment unit (92). In some examples, when initially attached to the electrically powered equipment unit, device 10 may not yet know the type of the device to which it is attached. Processing circuitry 14 may send the sampled power consumption signal to gateway 30 and further to server 32 (94). Gateway 30 and/or server may receive the sampled power consumption signals and determine the type of equipment and retrieve from a memory a description of an expected characteristic operating signature for the equipment. As described above in relation to FIGS. 8A-11B, the operating signature may be a rune that describes transition points for the electrically powered equipment unit.

Said another way, processing circuitry of a server, e.g., server 32, or some other processing circuitry operatively coupled to performance monitoring device 10, may receive the detailed power consumption signals from performance monitoring device 10 and compare the operating signatures to a database of characteristic operating signatures stored at a computer readable storage medium operatively coupled to the server. The processing circuitry may determine which characteristic operating signature is closest to the power consumption signals from performance monitoring device 10. The processing circuitry may identify the equipment, e.g., an electric dryer, a refrigerator/freezer unit, a geothermal heat pump and so on. The processing circuitry may assemble a “word” made up of runes that describe the operational cycle of the identified equipment and download the word to performance monitoring device 10.

Device 10 may receive from the server programming instructions, e.g., a rune or a word of several runs, that when executed by processing circuitry 14 of device 10, cause processing circuitry 14 to compare the power consumption signals sampled by device 10 to the received programming instructions. In other words, the received programming instructions may include a word including runes. The word may describe an operational cycle for the electrically powered equipment unit as described above in relation to FIGS. 11A and 11B and may include performance boundaries for the power consumption signals as described above in relation to FIGS. 3A and 3B.

Processing circuitry 14 may store the received word at a memory location within memory 17 operatively coupled to processing circuitry 14. Processing circuitry 14 may compare the monitored power consumption signals to the received word. In some examples, device 10 may compare recorded sampled power signals stored at memory 17 to the received rune. In other examples, device 10 may compare sampled power signals from subsequent operational cycles of the electrically powered equipment unit to the received word (98).

Based on the comparison, processing circuitry 14 may output an indication of a state of health of the electrically powered equipment unit (99). As described above in relation to FIG. 7, in some examples, the state of health may simply be a signal that the electrically powered equipment unit successfully completed an operational cycle within expected parameters. In other examples, the indication of the state of health (SOH) may include more details, such as the magnitude of the transition points and duration between transition points, as described above in relation to FIGS. 11A and 11B. In other examples, device 10, or gateway 30, may only send an indication of the SOH when the electrically powered equipment unit appears to be operating outside expected thresholds, e.g., outside expected timing and duration and/or outside of expected high and low performance boundaries for each transition.

The techniques of this disclosure may also be described by the following examples:

Example 1: A method includes monitoring, by processing circuitry, power consumption signals for an electrically powered equipment unit; sampling, by the processing circuitry, the power consumption signals; sending, by the processing circuitry, the sampled power consumption signal to a server; receiving, from the server, programming instructions that when executed by the processing circuitry, cause the processing circuitry to compare the sampled power consumption signals to the received programming instructions, wherein the received programming instructions comprise a word including runes, wherein the word describes an operational cycle for the electrically powered equipment unit and includes performance boundaries for the power consumption signals; storing, by the processing circuitry, the received word at a memory location operatively coupled to the processing circuitry; comparing the monitored power consumption signals to the received word; outputting an indication of a state of health of the electrically powered equipment unit based on the comparison.

Example 2: The method of example 1, further includes determining whether the monitored power consumption signals are within the performance boundaries; in response to determining that the monitored power consumption signals are within the performance boundaries, outputting the indication of the state of health that comprises an indication that the electrically powered equipment unit is operating as expected.

Example 3: The method of any of examples 1 and 2, wherein a first power consumption signal of the monitored power consumption signals is outside of the performance boundaries for a first rune associated with the first power consumption signal, and wherein the indication of the state of health comprises an indication that the electrically powered equipment unit needs attention.

Example 4: The method of any combination of examples 1 through 3, wherein the indication of the state of health comprises an indication that a first component of the electrically powered equipment unit associated with the first rune is expected to fail and needs urgent attention.

Example 5: The method of any combination of examples 1 through 4, wherein the indication of the state of health comprises an indication of a specific type of failure mode for the electrically powered equipment.

Example 6: The method of any combination of examples 1 through 5, wherein the indication of the state of health comprises an indication that a component of the electrically powered equipment unit operated out of sequence for the operational cycle described by the word.

Example 7: The method of any combination of examples 1 through 6, wherein, operating out of sequence comprises an unexpected, repeated operation of the component during the operational cycle.

Example 8: The method of any combination of examples 1 through 7, wherein comparing the monitored power signals to the received word comprises: parsing the power consumption signals into predetermined portions; identifying a respective rune of the runes comprising the word, corresponding to each respective predetermined portion; comparing each respective rune, at a first scale, to the corresponding respective predetermined portion.

Example 9: The method of any combination of examples 1 through 8, further comprising; in response to comparing a first rune at the first scale to a corresponding first respective portion; comparing the first rune at a second scale to the corresponding first respective portion.

Example 10: The method of any combination of examples 1 through 9, wherein the indication of the state of health comprises an indication at a first component of the electrically powered equipment unit was replaced by a second component, wherein: the first component is the same type of component as the second component, and the second component performs the same function as the first component.

Example 11: A device configured to monitor electrically powered equipment includes receive information from the sensor; store power consumption data at the memory based on information received from the sensor; store a word comprising runes, wherein the word describes an operational cycle for the electrically powered equipment and includes performance boundaries for the power consumption data; compare the power consumption data to the stored word; output an indication of a state of health of the electrically powered equipment based on the comparison.

Example 12: The device of example 11, wherein the device is configured to output the indication of the state of health only when the power consumption data is outside the performance boundaries.

Example 13: The device of any of examples 11 and 12, wherein the power consumption data is outside of the performance boundaries for a first rune associated with a first component of the electrically powered equipment, and wherein the indication of the state of health comprises an indication that the electrically powered equipment needs attention.

Example 14: The device of any combination of examples 11 through 13, wherein the indication of the state of health comprises an indication at a first component of the electrically powered equipment associated with a first rune was replaced by a second component, wherein: the first component is the same type of component as the second component, and the second component performs the same function as the first component; and wherein the device is configured to receive an updated word, wherein the updated word comprises a second rune, and wherein the second rune replaced the first rune in the updated word.

Example 15: The device of any combination of examples 11 through 14,

wherein the indication of the state of health comprises an indication that a component of the electrically powered equipment operated out of sequence for the operational cycle described by the word.

Example 16: A system configured to monitor electrically powered equipment includes receive information from the sensor; store power consumption data at the memory based on information received from the sensor; store a word comprising runes, wherein the word describes an operational cycle for the electrically powered equipment and includes performance boundaries for the power consumption data; compare the power consumption data to the stored word; output an indication of a state of health to the server of the electrically powered equipment unit based on the comparison.

Example 17: The system of example 16, further includes receive the indication of the state of health from the performance monitoring device; output the indication of the state of health to the server; receive data from the server; output the data to the performance monitoring device.

Example 18: The system of any of examples 16 and 17, wherein the device is configured to output the indication of the state of health only when the power consumption data is outside the performance boundaries.

Example 19: The system of any combination of examples 16 through 18, wherein the power consumption data is outside of the performance boundaries for a first rune associated with a first component of the electrically powered equipment, and wherein the indication of the state of health comprises an indication that the electrically powered equipment needs attention.

Example 20: The system of any combination of examples 16 through 19, wherein the indication of the state of health comprises an indication at a first component of the electrically powered equipment associated with a first rune was replaced by a second component, wherein: the first component is the same type of component as the second component, and the second component performs the same function as the first component; and wherein the device is configured to receive an updated word, wherein the updated word comprises a second rune, and wherein the second rune replaced the first rune in the updated word.

Various examples of the disclosure have been described. These and other examples are within the scope of the following claims.

What is claimed is:

1. A method comprising:
monitoring, by processing circuitry, power consumption signals for an electrically powered equipment unit;
sampling, by the processing circuitry, the power consumption signals;
sending, by the processing circuitry, the sampled power consumption signal to a server;
receiving, from the server, programming instructions that when executed by the processing circuitry, cause the processing circuitry to compare the sampled power consumption signals to the received programming instructions,
wherein the received programming instructions comprise data describing an operational cycle for the electrically powered equipment unit and includes performance boundaries for the power consumption signals;
storing, by the processing circuitry, the received data at a memory location operatively coupled to the processing circuitry;
comparing the monitored power consumption signals to the received data;
outputting an indication of a state of health of the electrically powered equipment unit based on the comparison.

2. The method of claim 1, further comprising:
determining whether the monitored power consumption signals are within the performance boundaries;
in response to determining that the monitored power consumption signals are within the performance boundaries, outputting the indication of the state of health that comprises an indication that the electrically powered equipment unit is operating as expected.

3. The method of claim 1,
wherein a first power consumption signal of the monitored power consumption signals is outside of the performance boundaries for a first received data associated with the first power consumption signal, and
wherein the indication of the state of health comprises an indication that the electrically powered equipment unit needs attention.

4. The method of claim 1, wherein the indication of the state of health comprises an indication that a first component of the electrically powered equipment unit associated with the first received data is expected to fail and needs urgent attention.

5. The method of claim 4, wherein the indication of the state of health comprises an indication of a specific type of failure mode for the electrically powered equipment.

6. The method of claim 1, wherein the indication of the state of health comprises an indication that a component of the electrically powered equipment unit operated out of sequence for the operational cycle described by the received data.

7. The method of claim 6, wherein, operating out of sequence comprises an unexpected, repeated operation of the component during the operational cycle.

8. The method of claim 1,
wherein the received data describing the operational cycle for the electrically powered equipment is in the form of a word comprising runes,
wherein comparing the monitored power signals to the received data comprises:
parsing the power consumption signals into predetermined portions;
identifying a respective rune of the runes comprising the word, corresponding to each respective predetermined portion;
comparing each respective rune, at a first scale, to the corresponding respective predetermined portion.

9. The method of claim 8, further comprising;
in response to comparing a first rune at the first scale to a corresponding first respective portion;
comparing the first rune at a second scale to the corresponding first respective portion.

10. The method of claim 1, wherein the indication of the state of health comprises an indication at a first component of the electrically powered equipment unit was replaced by a second component, wherein:
the first component is the same type of component as the second component, and
the second component performs the same function as the first component.

11. A device configured to monitor electrically powered equipment, the device comprising:
a sensor configured measure electrical power consumed by the electrically powered equipment;
a memory comprising computer readable storage media;
processing circuitry operatively coupled to the sensor and the memory, the processing circuitry configured to:
receive information from the sensor;
store power consumption measurements at the memory based on information received from the sensor;
store data describing an operational cycle for the electrically powered equipment, which includes performance boundaries for the power consumption data;
compare the power consumption measurements to the stored data;
output an indication of a state of health of the electrically powered equipment based on the comparison.

12. The device of claim 11, wherein the device is configured to output the indication of the state of health only when the power consumption data is outside the performance boundaries.

13. The device of claim 11,
wherein the power consumption data is outside of the performance boundaries for a first received data associated with a first component of the electrically powered equipment, and
wherein the indication of the state of health comprises an indication that the electrically powered equipment needs attention.

14. The device of claim 11,
wherein the received data describing the operational cycle for the electrically powered equipment is in the form of a word comprising runes,
wherein the indication of the state of health comprises an indication that a first component of the electrically powered equipment associated with a first rune of the word was replaced by a second component, wherein:
the first component is the same type of component as the second component, and
the second component performs the same function as the first component; and
wherein the device is configured to receive an updated word, wherein the updated word comprises a second rune, and wherein the second rune replaced the first rune in the updated word.

15. The device of claim 11, wherein the indication of the state of health comprises an indication that a component of the electrically powered equipment operated out of sequence for the operational cycle described by the received data.

16. A system configured to monitor electrically powered equipment, the system comprising:
a server comprising first processing circuitry;
a performance monitoring device comprising:
a sensor configured measure electrical power consumed by the electrically powered equipment;
a memory comprising computer readable storage media;
second processing circuitry operatively coupled to the sensor and the memory; the second processing circuitry configured to:
receive information from the sensor;
store power consumption data at the memory based on information received from the sensor;
store data describing an operational cycle for the electrically powered equipment, which includes performance boundaries for the power consumption measurements;
compare the power consumption measurements to the stored word;
output an indication of a state of health to the server of the electrically powered equipment unit based on the comparison.

17. The system of claim 16, further comprising a gateway device configured to communicate with the performance monitoring device, wherein to communicate with the performance monitoring device comprises:
receive the indication of the state of health from the performance monitoring device;
output the indication of the state of health to the server;
receive the data describing the operational cycle for the electrically powered equipment from the server;
output the data to the performance monitoring device.

18. The system of claim 16, wherein the device is configured to output the indication of the state of health only when the power consumption data is outside the performance boundaries.

19. The system of claim 16,
wherein the power consumption data is outside of the performance boundaries for a first received data associated with a first component of the electrically powered equipment, and
wherein the indication of the state of health comprises an indication that the electrically powered equipment needs attention.

20. The system of claim 16,
wherein the received data describing the operational cycle for the electrically powered equipment is in the form of a word comprising runes,
wherein the indication of the state of health comprises an indication at a first component of the electrically powered equipment associated with a first rune of the word was replaced by a second component, wherein:
the first component is the same type of component as the second component, and
the second component performs the same function as the first component; and
wherein the device is configured to receive an updated word, wherein the updated word comprises a second rune, and wherein the second rune replaced the first rune in the updated word.
